(19) United States
(12) Patent Application Publication
(10) Pub. No.: US 2024/0088653 A1
(43) Pub. Date: Mar. 14, 2024

(54) AUTO BOOST BATTERY SYSTEM

(71) Applicant: Reggie Lex Daverman, Orlando, FL (US)

(72) Inventor: Reggie Lex Daverman, Orlando, FL (US)

(21) Appl. No.: 18/244,596

(22) Filed: Sep. 11, 2023

Related U.S. Application Data
(60) Provisional application No. 63/406,503, filed on Sep. 14, 2022.

(51) Int. Cl. H02J 1/10; B60R 16/023; B60R 16/033; H02J 7/00; H02J 7/34

(52) U.S. Cl. CPC H02J 1/122; B60R 16/0234; B60R 16/0238; B60R 16/033; H02J 7/0048; H02J 7/342; H02J 2310/40

(57) ABSTRACT

A battery boost system includes a battery boost device having a main body with hardware for being permanently mounted within a vehicle. The device includes an internally located battery pack, a controller, a user interface, and a power regulation unit. A pair of power cables connect the boost device to the electrical terminals of a vehicle battery. A wireless communication unit is positioned within the main body and communicates with a mobile application on an externally located processor enabled device. The mobile application includes functionality for sending and receiving information with the device controller. The application displays vehicle battery voltage, amperage, short circuit status and operating condition. The mobile application selectively instructs the device to provide jumpstart power from the battery pack to the vehicle battery.

### CROSS-REFERENCE TO RELATED APPLICATIONS

This application claims the benefit of U.S. Application Ser. No. 63/406,503 filed on Sep. 14, 2022, the contents of which are incorporated herein by reference.

### TECHNICAL FIELD

The following disclosure relates generally to vehicular electric components, and more particularly to an auto boost battery system for providing diagnostic and remote jump start capability to a vehicle's primary battery system.

### BACKGROUND

The statements in this section merely provide background information related to the present disclosure and may not constitute prior art.

There are many instances where a vehicle battery loses charge and is unable to start the vehicle engine. In most cases, the vehicle owner had no advance notice that the battery was failing or that the voltage was dropping. As such, when these situations occur, the vehicle occupant must either call a mobile mechanic or a tow truck and then wait several hours for help. Alternatively, they must exit the safety of their vehicle in order to open the hood and attempt to charge the battery themselves.

When attempting the self-help method, the user must first attempt to locate the battery, and then must either use a portable jump box system (assuming they have one in their vehicle and assuming it is charged) or must request help from another motorist using jumper cables to receive power from a second vehicle.

Although this process can be performed relatively quickly by individuals with mechanical know-how, many more individuals lack the skill or confidence to attempt such a task. Indeed, there are numerous incidents reported each year of vehicular damage or injuries caused by individuals who do not connect to the charging terminals correctly. Moreover, some of these injuries occur wherein the users become injured by the moving parts of the engine when attempting to remove the charging cables after the vehicle has started.

Accordingly, it would be beneficial to provide an auto boost battery system that can continuously and remotely monitor a vehicle's primary battery system and that can provide a remotely-operated electrical jump to the same when needed.

### SUMMARY OF THE INVENTION

The present invention is directed to a battery boost system. One embodiment of the present invention can include a battery boost device having a main body having hardware for being permanently mounted within a vehicle, and preferably within the engine compartment of a vehicle. The device can include an internally located battery pack, a controller, a user interface, and a power regulation unit. A pair of power cables can connect the boost device to the electrical terminals of a vehicle battery.

The system can also include a mobile application for execution on an externally located processor enabled device. The mobile application can include functionality for sending and receiving information with the device controller. The application can display information such as the vehicle battery voltage, amperage, short circuit status and operating condition. The application can allow a user to instruct the device to provide power from the battery pack to the vehicle battery to jumpstart the same, and/or to receive power from the vehicle battery to provide a trickle charge to the battery pack.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of an auto boost battery system that is useful for understanding the inventive concepts disclosed herein.

FIG. 2 is a perspective view of the auto boost battery device of the auto boost battery system, in accordance with one embodiment of the invention.

FIG. 3 is a simplified block diagram of the electronic suite of the auto battery boost device, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

### Definitions

As described herein, a “unit” means a series of identified physical components which are linked together and/or function together to perform a specified function.

As described throughout this document, the term “about” “approximately” “substantially” and “generally” shall be used interchangeably to describe a feature, shape, or measurement of a component within a tolerance such as, for example, manufacturing tolerances, measurement tolerances or the like.

As described herein, the term “removably secured,” and derivatives thereof shall be used to describe a situation wherein two or more objects are joined together in a non-permanent manner so as to allow the same objects to be repeatedly joined and separated.

As described throughout this document, the term “complementary shape,” and “complementary dimension,” shall be used to describe a shape and size of a component that is identical to, or substantially identical to the shape and size of another identified component within a tolerance such as, for example, manufacturing tolerances, measurement tolerances or the like.

As described herein, the term “connector” includes any number of different elements that work alone or together to repeatedly join two items together in a nonpermanent manner. Several nonlimiting examples of connectors include but are not limited to thread-to-connect, twist-to-connect, and push-to-connect type devices, opposing strips of hook and loop material (e.g., Velcro®), attractively oriented magnetic elements or magnetic and metallic elements, buckles, clamps, sockets, clips, carabiners, compression fittings, latches, hooks, snaps and buttons, for example. Each illustrated connector and complementary connector can be permanently secured to the illustrated portion of the device via a permanent sealer such as glue, adhesive tape, or stitching, for example.

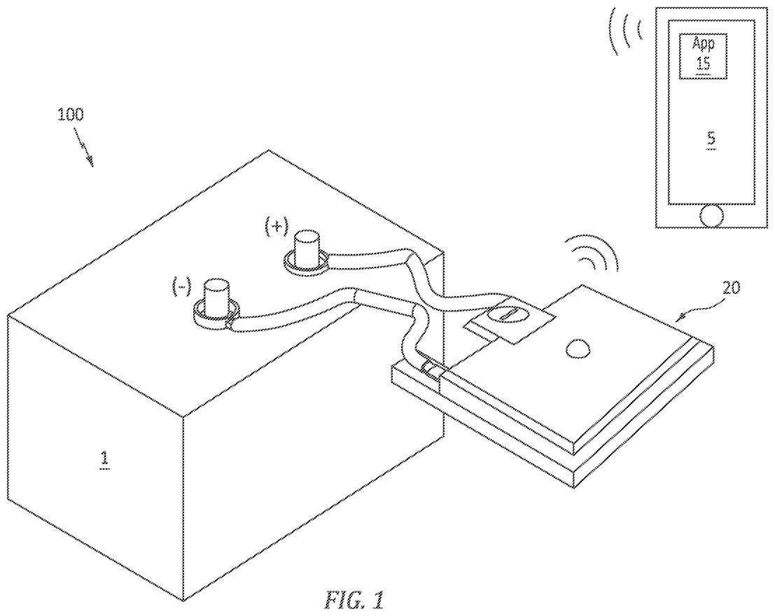

FIGS. 1-3 illustrate one embodiment of an auto boost battery system 100 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

As shown, one embodiment of the auto boost battery system 100 can include, essentially, a battery boost device 20 that is physically connected to a vehicle's primary battery system 1, and that is wirelessly connected to a processor enabled device 5 running an auto boost application 15.

As described herein, the auto boost application 15 can preferably include a mobile application (i.e., App) which can be downloaded and installed onto a smartphone 5 or another processor enabled device. The mobile application can function to utilize the communicative abilities of the processor enabled device to communicate wirelessly with the boost device 20 in order to send and receive information and operating instructions. As will be described below, the mobile application can enable a device user to monitor the status of the vehicle's primary battery system 1 (e.g., voltage, amperage, etc.), control the charge status of the device battery pack 25, and to provide an electrical voltage to the primary battery system from the device 20 sufficient to start the engine of the vehicle to which the system is secured. In some instances, the app 15 can include functionality for allowing a user to remotely track the location of the vehicle directly or through a third-party location service.

Although described above with regard to a smartphone App, this is for illustrative purposes only, as the application can include virtually any type of instruction sets, in any form of programming language that can be executed on any type of processor enabled device (e.g., computer, tablet, smartwatch, etc.).

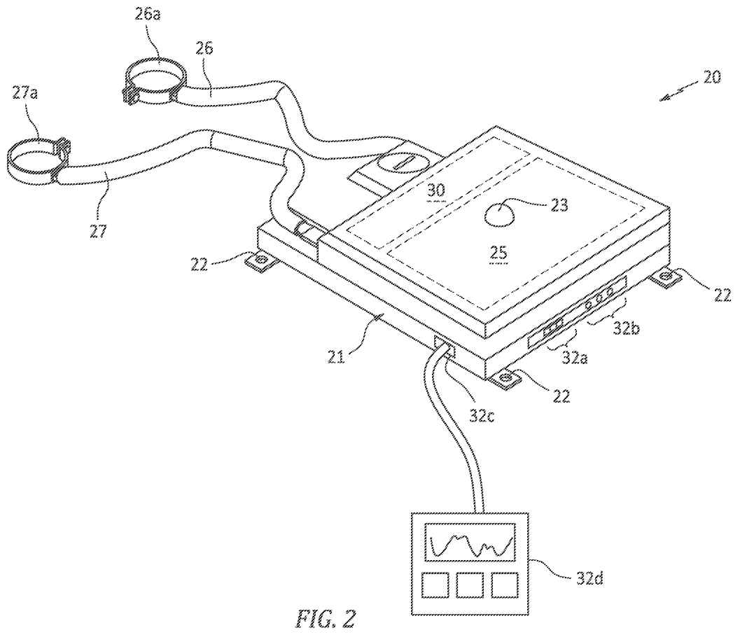

As shown best at FIG. 2, the boost device 20 can include a main body 21 having a plurality of walls that define an interior space for receiving and storing the below described electronic components. As described herein, the main body 21 is designed to be installed within the engine compartment or other such location in a permanent manner. As such, the main body can include internally located insulation, shock absorption tabs/padding and other such components so as to allow the electronic suite to operate 24 hours a day 365 days a year regardless of the extreme heat or cold.

As such, the main body may be formed from any number materials that are, for example, relatively strong and stiff for their weight, and that are suitable for creating an electrically isolative, insulated, and watertight interior space. Several nonlimiting examples include, but are not limited to various metals or metal alloys (e.g., aluminum, steel, titanium, or alloys thereof), plastic/polymers (e.g., high-density polyethylene (HDPE), rigid polyvinyl chloride (PVC), malleable polyethylene terephthalate (PET)), various composite materials (e.g., carbon fibers in a polymer matrix, fiberglass, etc.), and/or a layered construction having one or more of the above.

In one embodiment, the main body can include a plurality of mounting components such as apertures 22 for receiving connectors such as bolts or screws, for example, to allow the main body to be secured anywhere along or within the vehicle, but preferably within the engine compartment. In this regard, rubber washers or grommets will preferably be provided with the connectors to reduce vibrations on the main body. Of course, any number of other types of mounting components and connectors can be provided.

In one embodiment, the main body can include a directional antenna 23 which can be connected to the devices onboard electronic suite. The antenna can preferably extend through the main body to provide a stronger signal transmissions and receptions between the controller and externally located processor enabled devices.

As shown, a battery pack 25 can be positioned within the main body 21 and can function to selectively provide power to the device components, and to the vehicle's primary battery system upon command. As described herein, the battery pack 25 can include any number of individual rechargeable power cells which may be arranged serially and/or in parallel to produce a desired voltage such as 12 v, for example, and to produce an output amperage of between around 1000-2000 amps. Of course, other voltages and amperages are also contemplated.

In the preferred embodiment, the battery cells will include either lithium-ion batteries or lead-acid batteries; however, any number of other battery types are also contemplated. Although described as a battery pack, other embodiments are contemplated wherein a single battery is utilized.

As shown, a pair of elongated power cables 26 and 27 can extend from the main body. As will be described below, the power cables can function in a bi-directional manner for selectively receiving charging power from the vehicle battery, and for providing jumpstart power from the device 20 to the vehicle battery.

In one embodiment, each of the cables can include battery terminal connectors 26a and 27a along the distal ends. In the preferred embodiment, the cables can be constructed from a malleable and highly conductive material such as copper wires that are covered with an electrically insulative material such as EPR, for example. Of course, any number of other materials are also contemplated.

Although described and illustrated with regard to elongated flexible cables, other embodiments are contemplated wherein the main body includes fixed or moveable terminal connectors such that the main body itself is physically coupled to the primary battery via the terminal connectors.

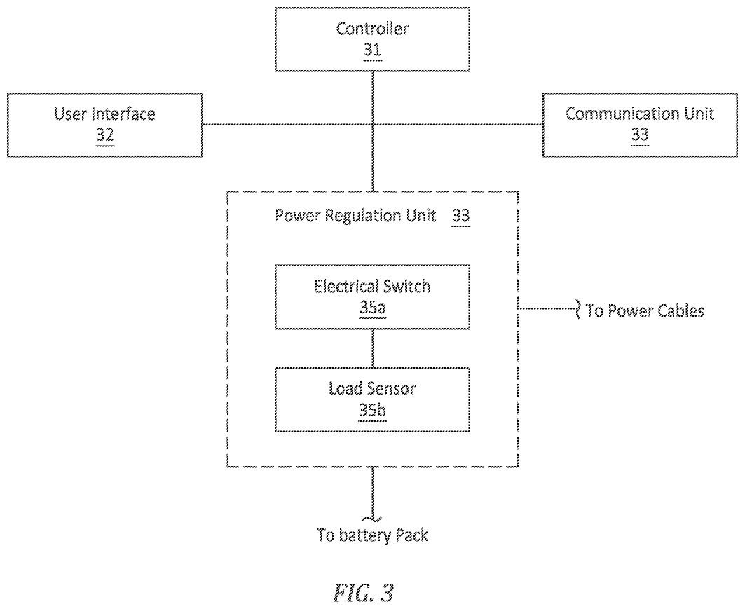

FIG. 3 illustrates one embodiment of the electronic suite of the battery boost device 20. As shown, the device can include a controller 31 that is in electrical communication with a user interface 32, a communication unit 33 and a power regulation unit 35.

Although illustrated as separate elements, those of skill in the art will recognize that one or more of the electronic suite components may include, comprise, or consist of one or more printed circuit boards (PCB) containing any number of integrated circuit or circuits for completing the activities described herein. Of course, any number of other analog and/or digital components capable of performing the below described functionality can be provided in place of, or in conjunction with the below described elements. The components of the electronic suite can be connected together in accordance with known methodologies using any number of components such as various communication cables, power cables, system bus components, pic controllers and the like, so as to achieve the functionality described herein.

The system controller 31 can function to control the operation of the battery boost device so as to operate in the manner described herein. In one embodiment, the controller 31 can include, comprise, or consist of one or more printed circuit boards (PCB) containing any number of integrated circuits to complete the activities described herein. To this end, the controller can include one or more processors and/or central processing units that are connected to one or more memory components for storing operating instructions in the form of program code for the processor(s) to execute.

In one embodiment, the controller can include or can be connected to a user interface 32 for sending and/or receiving operating instructions or information with a device user. As described herein, the user interface can include any number of different components capable of sending and/or receiving instructions from a device user. For example, the user interface 32 can include one or more distinct buttons 32a, or switches, along with any number of visual display elements 32b, such as multicolor LED lights, for example. In various embodiments, the device can include a display screen such as a touch screen for providing two-way communication with a device user.

The user interface components can function to allow a user to physically control the operation of the device in a number of different ways. For example, the button(s) can be operated by the user to initiate a wireless pairing operation with a remote device such as a user smartphone running a mobile application, and/or can function to initiate a jumpstart operation from the device 20 to the vehicle battery system. The visual display(s) can provide feedback to the user regarding the operational state and/or actions performed by the device.

In one embodiment, the device can include a cable connection receptacle 32c such as a USB receptacle, for example, for receiving a communications cable. The receptacle can function to interact with any number of external devices such as a wired controller interface screen 32d which can be positioned within the interior of the vehicle. The screen can function to display information such as the vehicle battery status, the device battery status, and can receive user inputs for operating the device (e.g., initiate trickle charge from the vehicle battery and/or initiate a jumpstart operation from the device to the vehicle battery) among others, for example.

The communication unit 33 can include any number of components capable of sending and/or receiving electronic signals wirelessly with an externally located device, either directly or over a network. In one embodiment, the communication unit can include a Bluetooth transceiver for communicating wirelessly with an external device such as the above-described smartphone device 5, for example, that is running the auto boost mobile application 15. Such a feature allowing a user within the vehicle or other location to utilize the auto boost device functionality such as to monitor the vehicle battery status, operate the charging circuitry, and/or to provide a jump start to the vehicle battery system 1 on command.

Of course, any number of other known transmission or reception protocols and components can be used. Several nonlimiting examples include, but are not limited to a cellular transceiver, a Wi-Fi transceiver, or a radio transceiver among others, for example.

The power regulation unit 35 can function to regulate the transfer of power between the vehicle battery 1 and the onboard battery pack 25. To this end, the power regulation unit 35 can include an electrical switch 35a and a load sensor 35b.

The electrical switch 35a can be controlled by the controller 31 and can selectively connect or disconnect the connection between the battery pack 25 and each of the cables 26 and 27. In operation, the controller can operate the switch based on feedback from the load sensor 35b to ensure the vehicle battery 1 is in a suitable condition for sending and/or receiving power from the device.

The load sensor 35b can function to measure load data from the vehicle battery 1 via the power cables. The load data can include the vehicle battery voltage, the vehicle battery amperage, and/or the vehicle battery electric short. The load data can be provided to the controller which can determine the operational condition of the vehicle battery.

For example, if the load data indicates the vehicle battery is experiencing an electrical short circuit, reverse polarity or overcharge situation, the controller can determine the operational condition of the vehicle battery is bad and can prevent power transfer between the boost device 20 and battery 1. Conversely, if the controller determines the vehicle battery is in an under-voltage situation, the controller can determine the operational condition of the vehicle battery is stable and can allow power transfer between the boost device 20 and battery 1 to charge the same.

In operation, the power regulation unit and the controller can function to regulate power received from the vehicle battery 1 to keep the onboard battery pack 25 in a fully charged state at all times. In the preferred embodiment, the controller can function to only receive power from the vehicle battery 1 when the vehicle is in an operating state whereby the vehicle alternator is actively charging the vehicle battery 1. At such a time, the controller can instruct the switch to receive power such as 12 volts at 1-10 amps to maintain the battery pack 25 in the fully charged condition (e.g., trickle charge). Of course, any number of other charge conditions and power levels are also contemplated.

Likewise, in instances when the vehicle battery 1 is dead or low, the controller can instruct the switch to supply power from the battery pack 25 to the vehicle battery 1 upon receipt of a user command via the mobile application 15, the user interface buttons 32a and/or interface device 32d. The power supplied to the vehicle battery can be hardwired within the controller or can be specified by the end user. For example, in a dead battery scenario, the system can supply 12 volts and between 400-600 amps to the vehicle battery suitable to jumpstart the engine. Of course, these are but a few possible options, and are provided for exemplary purposes only, as many other power levels are contemplated.

In either instance, the wireless communication unit can function to allow a user to remotely access and control the operation of the system. To this end, the user can remotely view the status of the vehicle battery 1 and the system battery pack 25, and to initiate a jumpstart of the vehicle battery without having to physically exit the vehicle, open the hood or physically connect jumper cable terminals.

In one embodiment, the system can also provide warnings to the user via the mobile application 15 and/or interface screen 32d, for example, regarding the electrical status of the vehicle. This information can include detected alternator performance of the vehicle as it charges the battery 1, low voltage status of the onboard battery, high voltage status of the onboard battery, electrical short detection, reverse polarity detection, etc., which permits the user to take preventative actions before a breakdown occurs.

In one embodiment, the wireless communication unit can function to report the location of the auto boost device 20 (and therefore the vehicle to which it is secured) to a user via the mobile app 15. Such a feature being beneficial in instances where the vehicle is stolen or where the mechanical breakdown requires assistance from a third party such as a tow truck, or police, for example.

As to a further description of the manner and use of the present invention, the same should be apparent from the above description. Accordingly, no further discussion relating to the manner of usage and operation will be provided.

As described herein, one or more elements of the device can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the term “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A battery boost system, comprising:
a main body having a plurality of walls and an interior space;
a plurality of power cables that extend from the main body;
a battery pack that is positioned within the main body; and
a controller that is positioned within the main body;
wherein the main body is configured to be permanently mounted within a vehicle, and the controller is configured to selectively transfer power from the battery pack to a vehicle battery that is connected to the plurality of power cables.

2. The system of claim 1, further comprising:
a power regulation unit that is positioned within the main body.

3. The system of claim 2, wherein the power regulation unit includes an electrical switch that selectively connects or disconnects an electric connection between the vehicle battery and the battery pack based on an instruction from the controller.

4. The system of claim 3, further comprising:
a wireless communication unit that is positioned within the main body, said wireless communication unit being configured to communicate with an external device.

5. The system of claim 4, wherein the controller is configured to receive operating instructions from the external device that is in communication with the wireless communication unit.

6. The system of claim 2, wherein the power regulation unit includes a load sensor.

7. The system of claim 6, wherein the load sensor includes functionality for measuring load data from the vehicle battery.

8. The system of claim 7, wherein the load data includes at least one of a vehicle battery voltage, a vehicle battery amperage, and a vehicle battery electric short.

9. The system of claim 8, wherein the controller includes functionality for selectively allowing or preventing a power transfer to the vehicle battery based on the load data.

10. The system of claim 1, wherein the main body includes mounting hardware for being permanently mounted to the vehicle.

11. The system of claim 1, further comprising:
a user interface device that is positioned on the main body.

12. The system of claim 11, wherein the user interface device includes at least one button for receiving a user command.

13. The system of claim 12, wherein the user interface device includes at least one light for communicating information to a system user.
